(19) United States
(12) Patent Application Publication
(10) Pub. No.: US 2003/0056349 A1
(43) Pub. Date: Mar. 27, 2003

(54) Method for repairing an eyeglass hinge having a failed screw

(76) Inventor: Milton R. Okun, Canton, MA (US)

Correspondence Address: Milton R. Okun, 115 Forbes Road, Milton, MA, 02186, US

(21) Appl. No.: 09/957,003

(22) Filed: Sep. 20, 2001

(51) Int. Cl. B23P 6/00

(52) U.S. Cl. 29/11; 29/20

(57) ABSTRACT

A method for repairing an eyeglass hinge having a failed screw so as to form a repaired eyeglass hinge utilizing a kit that includes a magnifying glass and a pair of strips. Each strip is slender, elongated, resilient, and tapers from a proximal end thereof to a distal end thereof so as to accommodate different sized eyeglass hinges, and the eyeglass hinge has a pair of mating portions. The method includes the steps of aligning the pair of mating portions of the eyeglass hinge utilizing the magnifying glass of the kit so as to form an aligned eyeglass hinge, inserting the distal end of one strip of the kit through the aligned eyeglass hinge in place of the failed screw, pulling the distal end of the one strip until such time as the one strip goes no further through the aligned eyeglass hinge indicating that the one strip is compressingly retained in the aligned eyeglass hinge so as to form a partially repaired eyeglass hinge, cutting the one strip just above the partially repaired eyeglass hinge, and cutting the one strip just below the partially repaired eyeglass hinge so as to form the repaired eyeglass hinge.

### BACKGROUND OF THE INVENTION

1. Field of the Invention

The present invention relates to a method. More particularly, the present invention relates to a method for repairing an eyeglass hinge having a failed screw.

2. Description of the Prior Art

Numerous innovations for fasteners have been provided in the prior art that will be described. Even though these innovations may be suitable for the specific individual purposes to which they address, however, they differ from the present invention in that they do not teach a method of repairing a broken eyeglass hinge.

FOR EXAMPLE, U.S. Pat. No. 3,665,800 to Ryder teaches snap-fasteners of multi-piece form that comprise a headed shank member and a sleeve member telescopically associated therewith. The sleeve member is secured in pre-determined spaced relation with respect to the work engaging side of the head and incorporates a laterally yieldable section to permit telescopic association thereof with a work aperture. The spacing of the sleeve with respect to the head is dependent upon a pre-selected lineal dimension of the shank, such dimension being determined by the thickness of the work to which the fastener is to be applied.

ANOTHER EXAMPLE, U.S. Pat. No. 3,678,797 to Seckerson teaches a resilient fastener comprising a head and a shank which is mountable in a workpiece formed with a circular aperture. The shank comprises a substantially flat and rigid stem, which is integral with the head and which extends lengthwise of the shank in a plane containing the longitudinal axis of the shank. Extending lengthwise of the shank on opposite sides of the stem are two resilient tongues each of which is joined to the stem along one longitudinal edge and each of which has a free longitudinal edge which is flexible towards the stem in a plane perpendicular to the plane of the stem. Preferably, an outwardly projecting rib is provided extending lengthwise along the free longitudinal edge of each tongue and each rib is shouldered adjacent the head.

STILL ANOTHER EXAMPLE, U.S. Pat. No. 4,104,952 to Brass teaches a child's toy construction system, similar in purpose to “Erector” sets, having reusable, distensible “rivets” instead of nuts and bolts, and a rivet “gun” to provide a feeling of authenticity in use. The system includes plates and bars to be joined together to create different structures. They are joined by use of the rivets passing through aligned holes in the plates and bars. The rivets are formed of bullet-shaped, soft distensible rubber pieces having a bore passing lengthwise through the rivet, but being closed at the leading end. The rivets have an outside diameter greater than the diameter of the holes, when the rivets are in their relaxed, undistended condition, and will, therefore, when not distended, expand to fill the holes and secure the pieces together. Their diameter is less than that of the holes when they are longitudinally distended. The base of the rivets is larger than the holes and includes an undercut gripping shoulder. Accordingly, the rivets may be inserted into and removed from the holes when distended. A “rivet gun” is provided for that purpose, having means to grip the shoulder and insert a stiff wire into the bore to distend (stretch) the rivet for insertion or removal. It may have a trigger linkage to “fire,” releasing the rivet and so adding greater authenticity.

YET ANOTHER EXAMPLE, U.S. Pat. No. 4,202,243 to Leonhardt teaches a rivet for pivotally securing a link to a bracket and adapted to compensate for tolerance variations in the thickness of the link and the bracket. A substantially hemispherical recess is formed in the shank end of the rivet while a counter-recess defined by a substantially hemispherical recess and by a frustoconical recess is formed in the head of the rivet.

STILL YET ANOTHER EXAMPLE, U.S. Pat. No. 4,363,160 to Wibrow teaches a fastening element of synthetic material comprising a sleeve-like hollow insert member adapted to be inserted into a prefabricated opening in a carrier plate and engaging beneath the underside of the opening edge by means of an undercut formed integrally therewith, and a head member connected to the insert member for fastening an article at the carrier member, with either the article to be fastened or the head member lying in close engagement with the side of the carrier plate opposite the undercut.

YET STILL ANOTHER EXAMPLE, U.S. Pat. No. 4,770,587 to Liljedahl teaches a locking pin formed from an elastic material having in its longitudinal direction a symmetrical cross-sectional configuration having two opposite outlines, one of which is formed by two straight lines extending from the ends of the pin and meeting between the ends to form an obtuse angle and a peak height measured from an opposite straight line, which connects two end points of the second outline of the locking pin, the peak height being larger than the diameter of the bore, into which the locking pin is to be inserted. The thickness of the pin at any point is less than the diameter of the bore, whereby the end points are positioned on a shoulder, which is formed at each end of the pin.

STILL YET ANOTHER EXAMPLE, U.S. Pat. No. 5,143,500 to Schuring et al. teaches a fastener system comprising a male or stud element with a split or bifurcated head, forming two prongs, that fits inside a female or socket sleeve. Inside the socket sleeve is an internal annular ring of a smaller diameter. The stud prongs deflect radially inwardly when pushed into contact with the internal ring until the prongs pass the ring at which point they deflect radially outwardly and lock the male member within the sleeve. This locking action allows for a variety of items to be clamped together along the length of the rivet sleeve provided that at each end of the rivet there is a head of larger diameter than that of the sleeve. Each head can be replaced by any number of integrally molded items requiring a locking/mating action or where locking and rotation is desired.

YET STILL ANOTHER EXAMPLE, U.S. Pat. No. 5,248,231 to Denham et al. teaches a self-plugging blind rivet that comprises a tubular body having a preformed head at one end, and in the bore of which a headed stem is disposed. The stem projects from the head end of the body, and the head of the stem is substantially enclosed by a region of the body remote from the preformed head. The head of the stem abuts a shoulder provided by a region of the body in which the diameter of the bore is reduced and the wall is thickened. Axially spaced apart annular grooves in the external surface of the body define between them a portion which will collapse to form a blind head when the body is compressed axially by pulling the stem while supporting the preformed head. Finally, the stem head may be pulled into the reduced diameter region of the bore and thereby cause the blind head to be reshaped and forced into compressive engagement with work being fastened. The stem head remains securely enclosed by the body, whereby its loss is prevented.

STILL YET ANOTHER EXAMPLE, U.S. Pat. No. 5,476,350 to Kurtz et al. teaches a push-in rivet for being mounted on and interconnecting a connector and a circuit board. The rivet body includes a head portion, a plurality of spaced-apart flexible legs, and a shank portion which interconnects the head portion and the legs. The legs are flexible and are subsequently radially inwardly movable for passage through a hole formed in the board and radially outwardly movable after passage through the hole so as to interconnect the connector and the board. The method of riveting the connector to the board includes the steps of passing the rivet through a hole in the connector so that the head portion abuts a surface of the connector, drawing a mandrel through the bore so as to outwardly expand the legs, and passing the legs of the rivet through a hole in the board so as to radially inwardly compress the legs for passing through the hole in the board and subsequently radially outwardly expanding the legs so as to secure the board to the connector.

YET STILL ANOTHER EXAMPLE, U.S. Pat. No. 5,738,475 to Chaban teaches an adjustable expansion pivot rivet for connecting a movable member to a fixed member having a cylindrical exterior surface, a hollow interior portion with a terminating portion, and a solid interior portion such that the hollow interior portion extends through the fixed member and the terminating portion and solid interior portion extends into the movable member, the hollow interior portion expanding in the hole of the fixed member to fill therein, and the termination portion and solid interior portion defining a gap forming a reservoir for lubricant in the movable member.

It is apparent that numerous innovations for fasteners have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a method for repairing an eyeglass hinge having a failed screw that avoids the disadvantages of the prior art.

ANOTHER OBJECT of the present invention is to provide a method for repairing an eyeglass hinge having a failed screw that is simple to use.

BRIEFLY STATED, STILL ANOTHER OBJECT of the present invention is to provide a method for repairing an eyeglass hinge having a failed screw so as to form a repaired eyeglass hinge utilizing a kit that includes a magnifying glass and a pair of strips. Each strip is slender, elongated, resilient, and tapers from a proximal end thereof to a distal end thereof so as to accommodate different sized eyeglass hinges, and the eyeglass hinge has a pair of mating portions. The method includes the steps of aligning the pair of mating portions of the eyeglass hinge utilizing the magnifying glass of the kit so as to form an aligned eyeglass hinge, inserting the distal end of one strip of the kit through the aligned eyeglass hinge in place of the failed screw, pulling the distal end of the one strip until such time as the one strip goes no further through the aligned eyeglass hinge indicating that the one strip is compressingly retained in the aligned eyeglass hinge so as to form a partially repaired eyeglass hinge, cutting the one strip just above the partially repaired eyeglass hinge, and cutting the one strip just below the partially repaired eyeglass hinge so as to form the repaired eyeglass hinge.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1C are a process flow chart of the present invention.

### LIST OF REFERENCE NUMERALS UTILIZED IN THE DRAWING

10 method of present invention for repairing eyeglass hinge 12 having failed screw 14

12 eyeglass hinge

14 failed screw of eyeglass hinge 12

15 repaired eyeglass hinge

16 kit

18 magnifying glass of kit 16

20 pair of strips of kit 16

22 proximal end of each strip of pair of strips 20 of kit 16

24 distal end of each strip of pair of strips 20 of kit 16

26 pair of mating portions of eyeglass hinge 14

28 aligned eyeglass hinge

30 partially repaired eyeglass hinge

### DETAILED DESCRIPTION OF THE PREFERRED EMBODIMENT

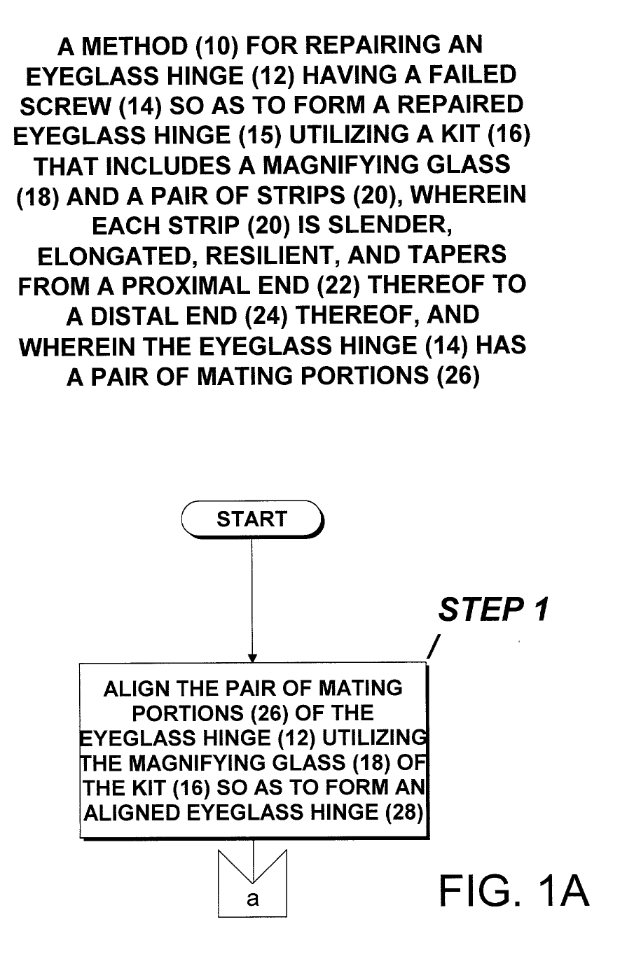

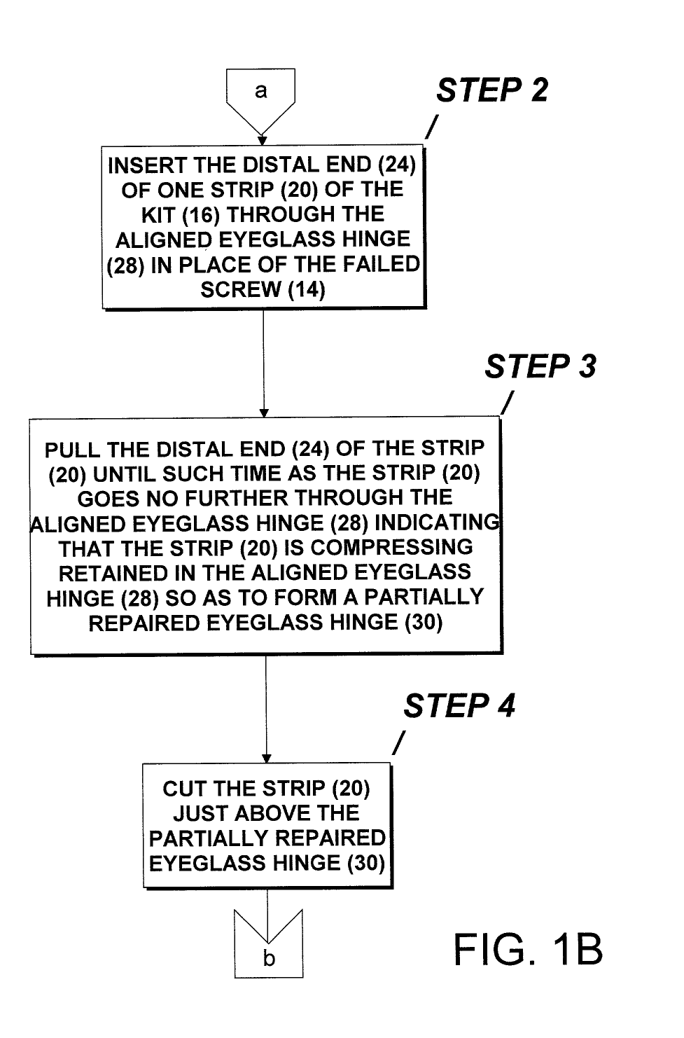

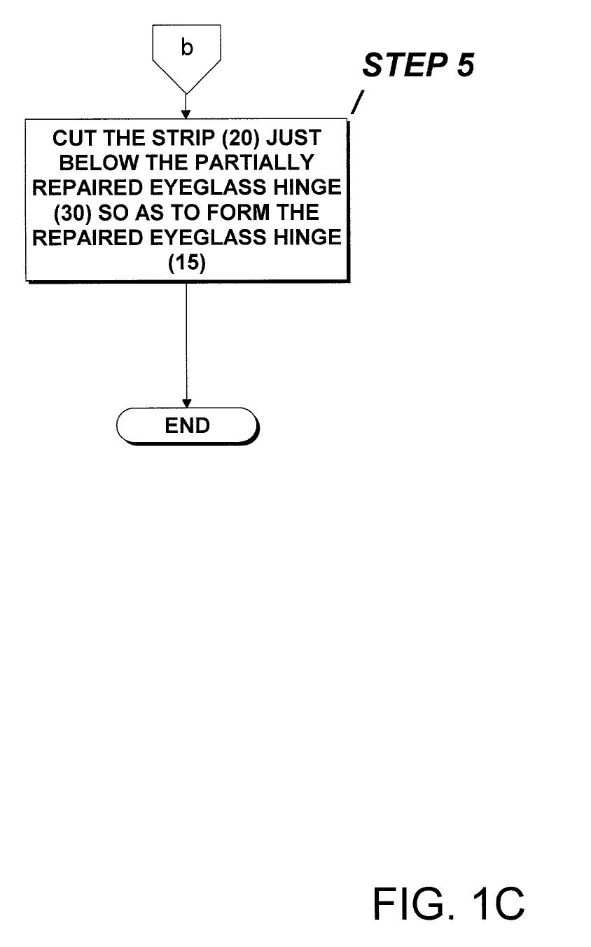

Referring now to the figures, in which like numerals indicate like parts, and particularly to FIGS. 1A-1C, which are a process flow chart of the present invention, the method of the present invention is shown generally at 10 for repairing an eyeglass hinge 12 having a failed screw 14 so as to form a repaired eyeglass hinge 15 utilizing a kit 16 that includes a magnifying glass 18 and a pair of strips 20. Each strip 20 is slender, elongated, resilient, and tapers from a proximal end 22 thereof to a distal end 24 thereof so as to accommodate different sized eyeglass hinges 14, and the eyeglass hinge 14 has a pair of mating portions 26.

The method 10 comprises the steps of:

| | |
|---|---|
| STEP 1: | Aligning the pair of mating portions 26 of the eyeglass hinge 12 |
| | utilizing the magnifying glass 18 of the kit 16 so as to form an |
| | aligned eyeglass hinge 28. |
| STEP 2: | Inserting the distal end 24 of one strip 20 of the kit 16 through |
| | the aligned eyeglass hinge 28 in place of the failed screw 14. |
| STEP 3: | Pulling the distal end 24 of the one strip 20 until such time as the |
| | one strip 20 goes no further through the aligned eyeglass hinge |
| | 28 indicating that the one strip 20 is compressingly retained in |
| | the aligned eyeglass hinge 28 so as to form a partially repaired |
| | eyeglass hinge 30. |
| STEP 4: | Cutting the one strip 20 just above the partially repaired eyeglass |
| | hinge 30. |
| STEP 5: | Cutting the one strip 20 just below the partially repaired eyeglass |
| | hinge 30 so as to form the repaired eyeglass hinge 15. |

It will be understood that each of the elements described above, or two or more together, may also find a useful application in other types of constructions differing from the types described above.

While the invention has been illustrated and described as embodied in a method for repairing an eyeglass hinge having a failed screw, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A method for repairing an eyeglass hinge having a failed screw so as to form a repaired eyeglass hinge utilizing a kit that includes a magnifying glass and a pair of strips, wherein each strip is slender, elongated, resilient, and tapers from a proximal end thereof to a distal end thereof so as to accommodate different sized eyeglass hinges, and wherein the eyeglass hinge has a pair of mating portions, said method comprising the steps of:
a) aligning the pair of mating portions of the eyeglass hinge so as to form an aligned eyeglass hinge;
b) inserting the distal end of one strip of the kit through the aligned eyeglass hinge in place of the failed screw; and
c) pulling the distal end of the one strip until such time as the one strip goes no further through the aligned eyeglass hinge so as to form a partially repaired eyeglass hinge.

2. The method as defined in claim 1, further comprising the step of cutting the one strip just above the partially repaired eyeglass hinge.

3. The method as defined in claim 2, further comprising the step of cutting the one strip just below the partially repaired eyeglass hinge so as to form the repaired eyeglass hinge.

4. The method as defined in claim 1, wherein said step of aligning the pair of mating portions of the eyeglass hinge so as to form an aligned eyeglass hinge includes aligning the pair of mating portions of the eyeglass hinge utilizing the magnifying glass of the kit so as to form an aligned eyeglass hinge.

5. The method as define din claim 1, wherein said step of inserting the distal end of one strip of the kit through the aligned eyeglass hinge includes inserting the distal end of one strip of the kit through the aligned eyeglass hinge in place of the failed screw.

6. The method as define din claim 1, wherein said step of pulling the distal end of the one strip until such time as the one strip goes no further through the aligned eyeglass hinge so as to form a partially repaired eyeglass hinge includes pulling the distal end of the one strip until such time as the one strip goes no further through the aligned eyeglass hinge indicating that the one strip is compressingly retained in the aligned eyeglass hinge so as to form a partially repaired eyeglass hinge.
